(19) United States
(12) Patent Application Publication
(10) Pub. No.: US 2012/0015163 A1
(43) Pub. Date: Jan. 19, 2012

(54) SUPPORT STRUCTURES FOR VARIOUS APPARATUSES INCLUDING OPTO-ELECTRICAL APPARATUSES

(76) Inventors: Gang HE, Cupertino, CA (US); Thomas J. GMITTER, Sunnyvale, CA (US); Melissa ARCHER, San Jose, CA (US)

(21) Appl. No.: 13/012,741

(22) Filed: Jan. 24, 2011

Related U.S. Application Data
(60) Provisional application No. 61/297,692, filed on Jan. 22, 2010.
(60) Provisional application No. 61/297,702, filed on Jan. 22, 2010.

(51) Int. Cl. B32B 7/02; B05D 3/00; B05D 5/10; B32B 15/04

(52) U.S. Cl. 428/212; 428/457; 427/331; 427/207.1

(57) ABSTRACT

Present embodiments generally relate to support structures for thin film components and methods for fabricating the support structures. In one embodiment, an apparatus comprises a device structure including portions of an electronic device; a support structure coupled to the device structure; wherein the support structure supplements features of the device structure and the support structure includes: a metal component coupled to the device structure; and a non-metal component coupled to the metal component. The support component can supplement structural and mechanical integrity of the device structure and functional operations of the device structure. In one embodiment, the metal component includes at least one layer of metal material and the non-metal component includes at least one layer of non metal material (e.g., polymeric material, etc.). The metal component can have greater stiffness characteristics with respect to the device structure and the non-metal component can have greater flexibility characteristics with respect to the metal layer component. The support structure can be configured to reflect light towards the device structure. The support structure can also be configured to conduct electricity from the device structure.

### RELATED APPLICATIONS

The present Application claims the benefit of and priority to Provisional Application 61/297,692 (Attorney Docket Number ALTA/0022L) entitled “Laminated Metallic Support Films For Epitaxial Lift Off Stacks” filed Jan. 22, 2010 and Provisional Application 61/297,702 (Attorney Docket Number ALTA/0022L02) entitled “Methods For Forming Epitaxial Lift Off Stacks Containing Laminated Metallic Support Films” filed Jan. 22, 2010, which are both incorporated herein by reference.

### FIELD OF THE INVENTION

Embodiments of the invention generally relate to the fabrication and use of various apparatuses (e.g., including photovoltaic, opto-electric, optical, semiconductor, electronic thin film devices, etc.) and more, particularly in some embodiments configuration and fabrication of support structures associated with the apparatuses.

### BACKGROUND OF THE INVENTION

Various devices and circuits are often utilized in a number of applications to achieve advantageous results. The devices and circuits can be utilized to increase productivity and reduce costs in a variety of activities (e.g., power generation, information processing, communication, etc.). The devices (e.g., including photovoltaic devices, solar conversion devices, opto-electric devices, optical devices, photonic devices, mechanical devices, semiconductor devices, electronic thin film devices, other thin film devices, etc.) can include thin films or layers. Manufacturing and utilizing thin film devices can be very complex and complicated.

Thin film components can be very difficult to manufacture and handle since the films are typically very fragile and have narrow dimensions. The manufacturing processes and after manufacture use environments can be comparatively harsh and detrimental to the relatively delicate characteristics and features of thin film devices. The thin films can be very susceptible to physical damage (e.g., cracking and breaking under very small forces, etc.). Thin film devices can include relatively brittle components or characteristics that do not permit much or any deformation before structural or mechanical failure. Such failures can adversely affect production yields and in field use effectiveness of the thin film components.

### SUMMARY OF THE INVENTION

Present embodiments generally relate to support structures for thin film components and methods for fabricating the support structures. In one embodiment, an apparatus comprises a device structure including portions of a device; and a support structure coupled to the device structure; wherein the support structure supplements features of the device structure. The support structure can include a metal component coupled to the device structure. The support structure can include a non-metal component coupled to the metal component. The support component can supplement structural and mechanical integrity of the device structure. The support component can supplement functional operations of the device structure. In one embodiment, the metal component includes at least one layer of metal material. In one embodiment, the non-metal component includes at least one layer of non-metal material (e.g., polymeric material, etc.). In one exemplary implementation, the metal component can have greater stiffness characteristics with respect to the device structure and the non-metal component can have greater flexibility characteristics with respect to the metal layer component. The support structure can be configured to reflect light towards the device structure. The support structure can also be configured to conduct electricity from the device structure.

### BRIEF DESCRIPTION OF THE DRAWINGS

The accompanying drawings, which are incorporated in and form a part of this specification, are included for exemplary illustration of the principles of the present embodiments and not intended to limit the present invention to the particular implementations illustrated therein. The drawings are not to scale unless otherwise specifically indicated.

FIG. 1A is a block diagram of a portion of an exemplary apparatus attached to a growth substrate by a sacrificial layer in accordance with one embodiment of the present invention.

FIG. 1B is a block diagram of a portion of an exemplary apparatus in which a support component includes a metal component and a non-metal component in accordance with one embodiment of the present invention.

FIG. 1C is a block diagram of a portion of an exemplary apparatus in a process of being separated from a growth substrate in accordance with one embodiment of the present invention.

FIG. 1D is a block diagram of an exemplary apparatus separated from a growth substrate in accordance with one embodiment of the present invention.

FIG. 1E is a flow chart of an exemplary thin film apparatus fabrication method in accordance with one embodiment of the present invention.

FIG. 1F is a block diagram of an exemplary support structure formation process in accordance with one embodiment of the present invention.

FIG. 2A is a block diagram of another exemplary support structure of an apparatus in accordance with one embodiment of the present invention

FIG. 2B is a block diagram of a portion of an exemplary apparatus separated from a growth substrate in accordance with one embodiment of the present invention

FIG. 3A is a block diagram of yet another exemplary support structure of an apparatus in accordance with one embodiment of the present invention.

FIG. 3B is a block diagram of a portion of an exemplary apparatus separated from a growth substrate in accordance with one embodiment of the present invention.

FIG. 3C is a block diagram of an exemplary apparatus with a dielectric structure in accordance with one embodiment of the present invention.

FIG. 4 is a graph illustrating tension-to-strain ratios of varying thicknesses of support layers in accordance with one embodiment of the present invention.

FIG. 5 is a graph illustrating laminate-to-film ratios of varying thicknesses of support layers in accordance with one embodiment of the present invention.

FIG. 6 is a graph illustrating strain-to-curvature ratios of varying thicknesses of support layers in accordance with one embodiment of the present invention.

FIG. 7 is a graph illustrating moment-to-strain ratios of varying thicknesses of support layers in accordance with one embodiment of the present invention.

### DETAILED DESCRIPTION

Reference will now be made in more detail to preferred embodiments, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit of the appended claims. Furthermore, in the following detailed description, numerous specific details are set forth in order to provide an understanding to one of ordinary skill in the art. However, one ordinarily skilled in the art will understand that the present invention may be practiced without these specific details. In some instances, other embodiments, methods, procedures, components, and circuits have not been described in detail as not to unnecessarily obscure aspects of the current invention.

Many of the present described embodiments generally relate to support structures associated with a variety of apparatuses (e.g., including photovoltaic devices, solar conversion devices, opto-electric devices, optical devices, photonic devices, mechanical devices, semiconductor devices, electronic thin film devices, other thin film devices, etc.). An apparatus can include a device structure and a support structure configured to supplement features of the device structure. The device structure and support structure can be configured in layers. It is appreciated there are a variety of ways in which the support structure can supplement (e.g., add to, enhance, aid, increase, etc.) features (e.g., functions, characteristics, etc.) of a device. A support structure can add and enhance structural and mechanical integrity (e.g., reduce susceptibility to cracking, breaking, etc.) while also aiding functional operations (e.g., increasing optical reflection, improving thermal conductivity, establishing electrical connectivity between components, etc.). The support structure can also be utilized to facilitate gripping and holding a thin film device structure (e.g., for alignment, etc.). It is appreciated the device structures and support structures can include a variety of configurations. In one exemplary implementation, the device structure can include a thin film layer. In one embodiment, the support structure can include at least one metallic layer. In one embodiment, the support structure can include at least one non-metallic layer (e.g., polymeric, co-polymeric, oligomeric, etc.). In one embodiment, a support structure can include both at least one metal layer and at least one non-metal layer. Additional information regarding embodiments of apparatuses including support structures is presented in following sections of the description.

The following descriptions are explained in many instances with respect to epitaxial lift off (ELO) thin film devices with support structures and methods used to form such devices and support structures. It is appreciated that the present invention is not limited to such embodiments and can be utilized in a variety of other configurations and applications. In some embodiments the support structures and methods can be associated with electronic devices, opto-electric devices or optical devices. It is also appreciated that terms such as comprising, including, containing, and so on are inclusive and open ended and do not exclude additional elements or process operations, whether recited or un-recited.

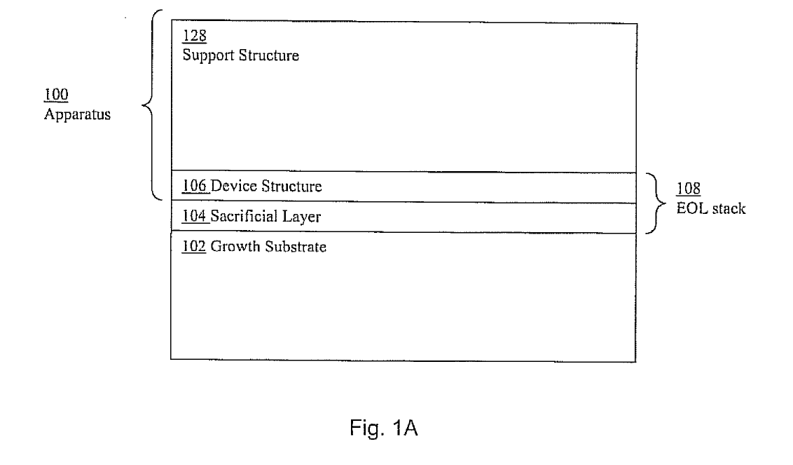

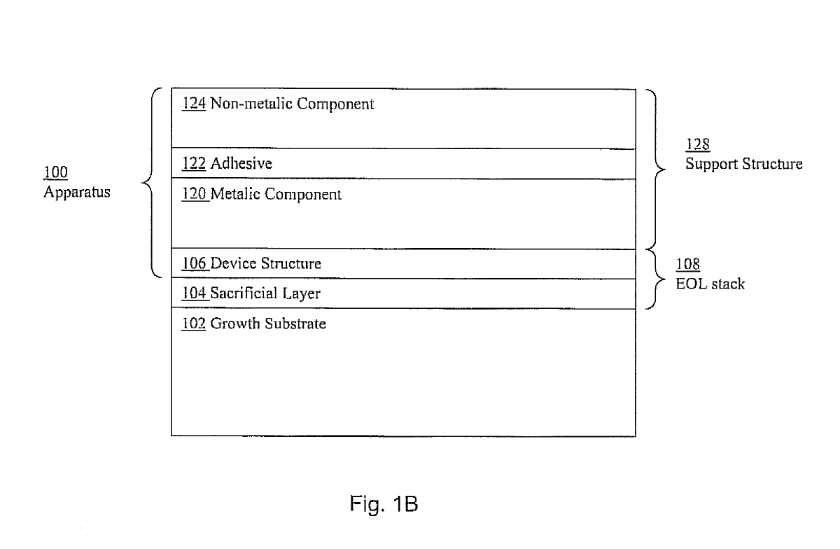

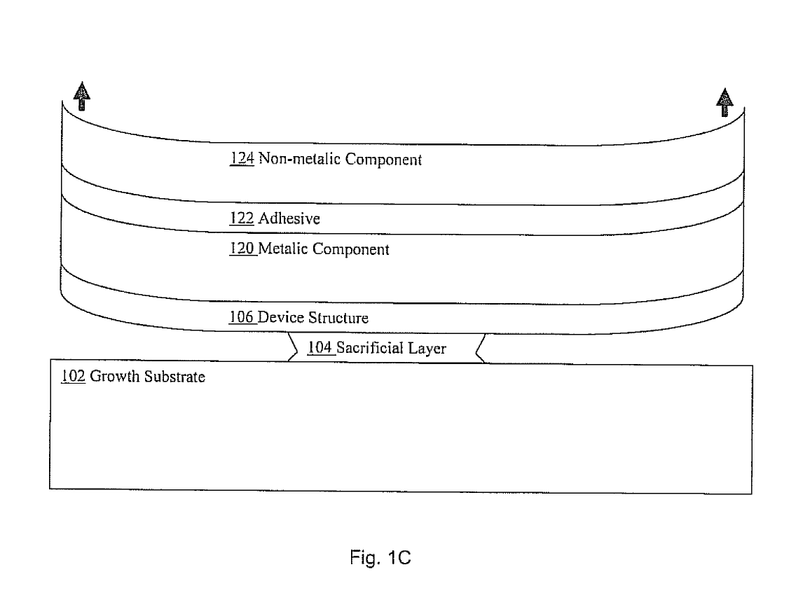

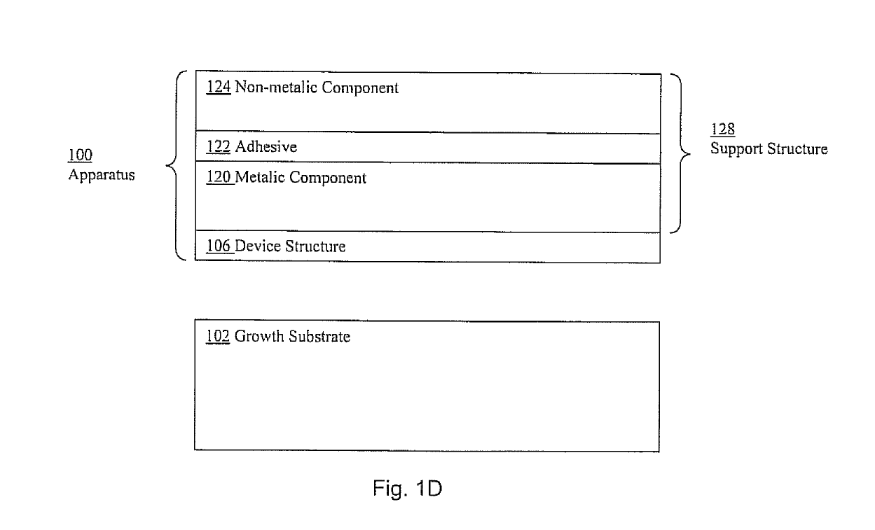

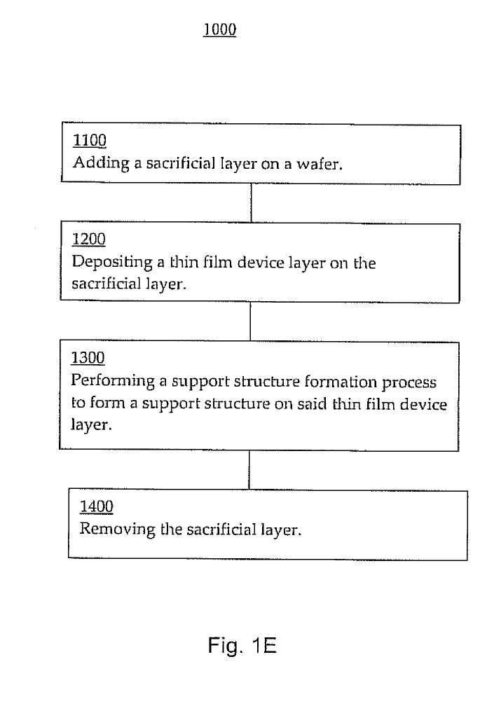

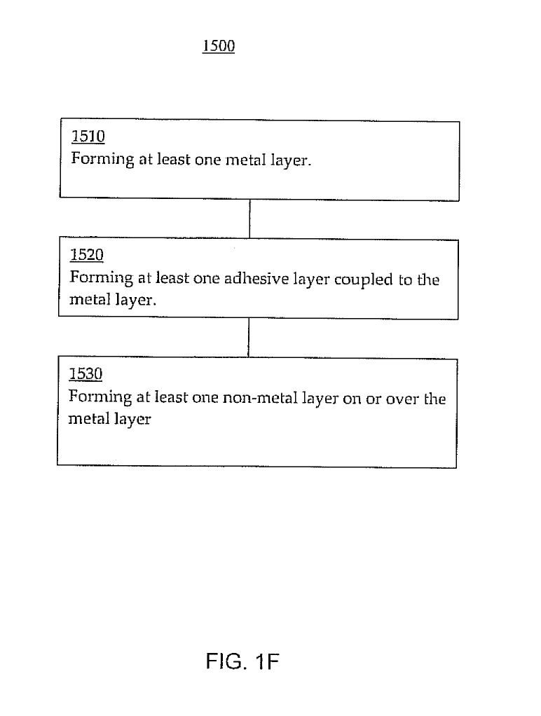

FIG. 1A is a block diagram of a portion of apparatus 100 attached to growth substrate 102 by sacrificial layer 104 in accordance with one embodiment of the present invention. Apparatus 100 includes support structure 128 and device structure 106. It is appreciated that support structure 128 can supplement a variety of features for apparatus 100. Support structure 128 can supplement structural and mechanical integrity of the device structure (e.g., enhance ability to avoid or withstand adverse impacts associated with cracking propagation, handling tension, bending radius, bending forces, etc.). Support structure 128 can also supplement functional operations of the device structure (e.g. reflect light towards device structure 106, conduct heat from device structure 106, conduct electricity from device structure 106, etc.). It is also appreciated that support structure 128 can include a variety of configurations.

FIG. 1B is a block diagram of apparatus 100 in which support structure 128 includes a metal component 120 and a non-metal component 124 in accordance with one embodiment of the present invention. The support structure 128 can also include an adhesive component 122 between the metal component 120 and non-metal component 124. Metal component 120 can include one or more layers of metal material (e.g., silver, nickel, copper, nickel-copper alloy, molybdenum, tungsten, cobalt, iron, manganese, alloys thereof, derivatives thereof, combinations thereof, etc.) and non-metal component 124 can include one or more layers of non-metallic material (e.g., a polymeric material, a co-polymeric material, an oligomeric material, polyethylene terephthalate polyester, polyethylene naphthalate, polyimide, derivatives thereof, etc). The formation and utilization of apparatuses including support structures are further described in following sections.

In one embodiment, a thin film is included in the device structure 106.

Applying a force to the device structure (e.g., bending, pulling, pressing, twisting, etc.) can induce stresses within the device structure. The ability of the device structure to withstand adverse impacts (e.g., deformation failure, crack induced failures, etc.) associated with the application of the force lies within the strength of the device structure 106 itself when not coupled to support structure 128. By itself, device structure 106 can be fragile and brittle and subject to cracking and breaking without support from support structure 128. When device structure 106 is coupled to support structure 128, support structure 128 can support the device structure 106 and supplement static and mechanical integrity.

The level of stiffness of the support structure can be an important property. Although soft support films (e.g., wax films) can provide compressive stress to the ELO film, the soft support film by itself can lead to larger local deformation under film stress and external forces than hard support films (e.g., harder than wax). For example, a wavy surface can provide a pathway of stress relaxation for the compressively stressed ELO film, while a periodically cracked surface can provide efficient stress relaxation for tensile stressed ELO film. Under strong compression, the ELO film may even buckle. When the support film is soft, there is little energy penalty against such surface modulations or strain. In addition, for a given external force, a soft support film can lead to a larger strain. If any local strain exceeds a critical point, the ELO film typically cracks. Once the ELO film cracks, the crack can be much easier to propagate with a soft support film since it allows larger deformation. While a stiff support film is not as susceptible to these issues, a stiff support film by itself may not possess sufficient yield strength and flexibility to avoid breaking (e.g., while being handled, etc.). The various possible configurations of a present support structure (e.g., at least one metal layer, at least one non-metal layer, both a metal and non-metal layer, etc.) enable realization of stiffness and flexibility characteristics that facilitate overcoming many of these issues.

It is appreciated that both the relative stiffness and flexibility of support structure 128 can contribute to the supplementing of various features of apparatus 100. The stiffness/flexibility of support structure 128 can supplement crack propagation resistance and prevention in device structure 106. Support structure 128 can include relatively flexible characteristics that supplement the static and mechanical integrity by introducing compressive stress to device structure 106. Propensity for crack spreading that may otherwise occur is reduced as cracks usually do not propagate readily through regions of residual compressive stress. In one embodiment, support structure 128 supplements compression at a “flat-film” condition. This can be achieved by coefficient thermal expansion (CTE) mismatch or by deposition-induced stress which are provided by the combination of metallic support component 120 and non-metallic support component 124. Support structure 128 can include relatively rigid characteristics that supplement the static and mechanical integrity by introducing tension tolerance. The stiffness/flexibility of support film 128 can be controlled by including either or both a relatively stiff or rigid support material (e.g., such as metallic support component 120, etc.) and a relatively flexible or soft support material (e.g., such as non-metal component 124, etc.). Additional information on materials that can comprise support components is included in following sections of the description.

An epitaxial lift off (ELO) thin film process can be utilized as part of a formation process of apparatus 100 and separation from growth substrate 102. In one exemplary implementation as shown in FIG. 1B, device structure 106 and sacrificial layer 104 are included in an ELO thin film stack 108 and the sacrificial layer 104 can be removed to separate the growth substrate 102 from apparatus 100.

FIG. 1C is a block diagram of a portion of apparatus 100 in a process of being separated from growth substrate 102 in accordance with one embodiment of the present invention. In one embodiment, a portion of apparatus 100 (e.g., including device structure 106 and support structure 128, etc.) is “peeled” from growth substrate 102 forming an etch crevice there between until the sacrificial layer 104 is etched away and the portion of apparatus 100 is separated from growth substrate 102. Support structure 128 can supplement (e.g., add to, enhance, aid, increase, etc.) structural integrity and mechanical integrity during the ELO process. Eventually, sacrificial layer 104 is completely or substantially removed and apparatus 100 is separated from growth substrate 102. FIG. 1D is a block diagram of apparatus 100 separated from growth substrate 102 in accordance with one embodiment of the present invention. The etching process can include introduction and exertion of forces on the apparatus 100 during the etching process to facilitate separation of the apparatus 100 from growth substrate 102.

The ELO process has many phases or steps and issues to be considered during each phase. Two rather distinct phases of the ELO process include the undercut-etch and the final-separation. Although related, these two phases have very different issues and critical parameters. In the undercut-etch phase, the main issues are film cracking and etch rate. Film cracking in this stage is mostly an issue of compressive stress control, and etch rate is strongly related to the radius of curvature, peeling tension, and the etch chemistry and temperature. In the final-separation phase, the main issue is ELO film cracking or re-bonding to the growth substrate or under-layer. Key parameters that affect the quality include film-growth substrate pressure, shear force, support handle/film stiffness, and the configuration of center mesa gap, if any. In both phases, the fundamental constraint of the ELO process is cracking of the ELO film, which limits the radius of curvature, the peeling tension, and the separation conditions.

Support structure 128 can aid in stabilization of the device structure 106 and facilitate in reduction of adverse impacts (e.g., associated with cracking propagation, handling tension, bending radius, bending forces, etc.) during the ELO processing (e.g., during separation of apparatus 100 from growth substrate 102, handling apparatus 100, etc.). Metal component 120 can keep a possible crack in device structure 106 from separating along the entire length of device structure 106. Therefore, the amount of stress relaxation as a result of crack propagation is limited by lateral displacement which is limited by the thickness of device structure 106. The stress relaxation is less for thinner ELO films, thus limiting the driving force of crack propagation.

To avoid cracking during the ELO etch, the device structure 106 can be kept under compression by the support structure 128. In order to maintain compression in the curled device structure during ELO, the support structure 128 provides compression at the flat-film condition. This can be achieved by CTE mismatch or by deposition-induced stress, which is provided by the combination of metal component 120 and non-metal component 124. Support structure 128 can be under tension while device structure 106 is under compression.

During final separation of device structure 106 from growth substrate 102, there can be a tendency to crack due to the highly concentrated stress in the remaining attached area on growth substrate 102 just before separation. Support structure 128 can limit the strain of device structure 106 under external stress. Besides the particular composition and thickness of support structure 128, the final pressure, shear force, and radius of curvature are also parameters that affect final separation during the ELO etching process.

For any given final separation condition, there is a crack dimension of remaining attached area below which the film can crack. The objective of a successful final separation is to find conditions under which the crack dimension is zero, or minimized enough to be completely contained in a final gap in epitaxial film mesa such that the final separation crack will not enter the active portion of device structure 106. In the latter case, the final gap accommodates both the crack dimension of the final crack and the variability of the final crack position, which may result from the etch rate non-uniformity or registration errors between the final gap and the ELO setup. Support structure 128 can facilitate containment in a final gap associated with device component 106 such that propensity for final separation cracking is reduced.

In many examples, the final pressure is expected to play a key role in final separation and the more negative the final pressure, the larger the crack dimension. This consideration favors a positive pressure between device structure 106 and growth substrate 102 during final separation. However, if the pressure is too positive, there may be a risk of film-substrate re-bonding after undercut is completed, or even incomplete undercut if too much pressure causes excessive local flattening of the separated device structure 106, leaving insufficient local curvature. Therefore there is a process window of the final pressure bounded by cracking in the low or negative side and by re-bonding or incomplete undercut in the high or positive side. A ramped pressure versus time can provide a wider process window by reducing the chance of incomplete undercut and re-bonding while providing a strong pressure to prevent cracking before undercut is completed. Support structure 128 can facilitate control of or compensation for the final pressure and also achievement of ramped pressure versus time.

In addition, thinner support structure 128 leads to less tensile stress buildup. When support structure 128 is laminated onto a carrier tape, the thickness of the overall laminate is greatly increased, so is the tensile stress due to curvature. There may be two ways to resolve this issue. One is to use an adhesive (e.g., adhesion layer 122, etc.) which is plastically deformable under the etch condition to relief stress buildup by allowing relative slide between support film 128 and non-metal component 124. The other is to use support film 128 that contains metal component 120 which is stiffer than non-metal component 124 so as to overpower the stress of non-metal component 124.

FIG. 1E is a flow chart of thin film apparatus fabrication method 1000 in accordance with one embodiment of the present invention. Thin film apparatus fabrication method 1000 can be implemented to form various apparatus configurations (e.g., including apparatus 100, apparatus 240, apparatus 340, apparatus 500, etc.).

In block 1100, a sacrificial layer is added on a growth substrate. In one embodiment, a growth substrate can be a wafer. Growth substrate 102 can include a variety of materials. The growth substrate material can be closely lattice matched or have a similar lattice constant to the material being grown. In one embodiment, the materials can include Groups III/V semiconductor materials, and may be doped with other elements. In one embodiment, growth substrate 102 contains gallium arsenide, doped gallium arsenide, gallium arsenide alloy, indium aluminum gallium phosphide alloys, indium aluminum phosphide alloys, indium gallium phosphide alloys, other group III/V semiconductors, germanium, materials with similar lattice constants, derivatives thereof, etc. The sacrificial layer may contain aluminum arsenide, gallium aluminum arsenide, derivatives thereof, alloys thereof, or combinations thereof. In some examples, growth substrate 102 is a gallium arsenide wafer. A sacrificial layer can be directly coupled to a growth substrate or indirectly coupled to the growth substrate. A sacrificial layer can be added directly over a growth substrate or indirectly over the growth substrate. In one embodiment, there can be an intervening layer (e.g., a buffer, etc.) between the growth substrate and the sacrificial layer.

In block 1200, a device structure is deposited on the sacrificial layer. The device structure can include a thin film device layer. A thin film device layer can include epitaxially grown layers which are formed on the sacrificial layer disposed on or over a growth substrate 102. The thin film device layer can be a plurality of layers containing Groups III/V epitaxially grown materials. In one embodiment, the thin film device layer is used as a photovoltaic device or solar cell or another device. A device structure can be directly coupled to a sacrificial layer or indirectly coupled to the sacrificial layer. A device structure can be added directly on or over a sacrificial layer or indirectly over the sacrificial layer. In one embodiment, there can be an intervening layer between the device structure and the sacrificial layer.

In block 1300, a support structure formation process is performed to form a support structure on the thin film device layer. In one embodiment, the support structure 128 is disposed on the opposite side of the epitaxial material than the growth substrate. A support structure can include one or more layers. The layers can include support films. A support structure can be directly coupled to a device structure or indirectly coupled to the device structure. A support structure can be added directly on or over a device structure or indirectly over the device structure. In one embodiment, there can be an intervening layer between the device structure and the support structure.

Additional information on support structure formation processes is described in following sections.

In block 1400, the sacrificial layer is removed. In one embodiment, during an ELO process the sacrificial layer is removed or etched away, thereby freeing or separating an apparatus from a growth substrate. In one exemplary implementation, an etch crevice is formed between device structure 106 and growth substrate 102 during the etching process, and as the etching process proceeds, the crevice continues to increase in length and angle while sacrificial material is removed from sacrificial layer 104. The etching process can also include introduction and exertion of forces on the apparatus 100 during the etching process to separate the apparatus 100 from growth substrate 102. In one embodiment, at least a portion of the device structure is peeled away from the growth substrate as part of the etching process.

The sacrificial layer is typically very thin and is usually etched away (e.g. via a wet chemical process, gaseous chemical process, plasma chemical process, etc.). The speed of the overall process may be limited by the lack of delivery or exposure of reactant(s) to the etch front, which leads to less removal of by products from the etch front. This described process is partially a diffusion limited process and if the films were maintained in their as deposited geometries, a very narrow and long opening would form to severely limit the overall speed of the process. To lessen the transport constraint of the diffusion processes, it may be beneficial to open up the resulting gap created by the etched or removed sacrificial layer and by bending the epitaxial layer away from the growth substrate. A crevice is formed between the epitaxial layer and the growth substrate—which geometry provides greater transport of species both towards and away from the etch front. Reactants move towards the etch front while by-products generally move away from the etch front while the device structure is bent or peeled back. However, the device structure or epitaxial layer is placed under tensile stress while bending the epitaxial layer away from the growth substrate since the epitaxial layer is on the outside of the curvature of the crevice. The tensile stress limits the amount of crevice curvature and reduces the speed of the etch process. To overcome this limitation, a residual compressive stress may be instilled within the epitaxial layer by the support structure 128 before etching the sacrificial layer. This initial compressive stress may offset the tensile stress caused by the bending and therefore allows for a greater amount bending during the separation process facilitating a faster etch rate.

The rate of the ELO undercut etch is in general a function of at least four parameters—the etch chemistry, the etch condition (temperature and pressure), the local radius of curvature of the crevice, and the local peeling tension. In some embodiments, sacrificial layer 104 is generally exposed to a wet etch solution during the etching process. In one embodiment, the wet etch solution can contain hydrofluoric acid, and may further contain additives (e.g., a surfactant, a buffer, inhibitor, etc.). The peeling tension is a function of curvature as well as the thickness and elasticity of non-metal component 124. The etch rate is limited by diffusion in a wet etch bath, which is inversely proportional to the square root of radius of curvature, and reaction rate, which is dependent on etch chemistry and condition as well as the peeling tension. The configuration of the metal component 120 and the non-metal component 124 in support structure 128 facilitate realization of advantageous radius of curvature and peeling tension that increase control of etch rates. It is appreciated that various etch rates can be achieved (e.g., sacrificial layer 104 may be etched at a rate of about 0.3 mm/hr, at about 5 mm/hr, at about 50 mm/hr, at rates between these values, at rates greater than 50 mm/hr, etc.), utilizing a present support structure to facilitate control of the etch rate.

FIG. 1F is a block diagram of a support structure formation process 1500 in accordance with one embodiment of the present invention. In one embodiment, support structure formation process 1500 can be utilized in block 1300 of thin film apparatus fabrication method 1000.

In block 1510 at least one metal layer coupled to the thin film device layer is formed. It is appreciated that more than one metal layer can be formed. In one embodiment, metal component 120 may be disposed or formed on or over device structure 106. In some embodiments, metal component 120 may be disposed directly on device structure 106. In other embodiments, metal component 120 may be disposed on a reflector layer and/or a barrier layer—disposed between metal component 120 and device structure 106. Metal component 120 may contain a single layer or multiple layers of the same or different metals. Each metal-containing layer of metal component 120 may be deposited or plated metals on to the under lying layer, or may be disposed thereon as solder, metallic tape, metallic foil, metallic film, metallic sheet, metallic strip, metallic plate, or combinations thereof. Metal component 120 may contain at least one metal selected from nickel, nickel alloys, copper, copper alloys, nickel-copper alloys, Ni—Cu alloy (MONEL® alloy), Ni/Cu/Ni laminate, Ni—P (e-less), cobalt, cobalt alloys, nickel-cobalt alloys, iron-nickel-cobalt alloys, Fe—Ni—Co alloy (KOVAR® alloy), nickel-molybdenum alloys, Ni—Mo alloy (HASTELLOY® B2 alloy), molybdenum-titanium alloys, Mo—Ti alloy (TZM® alloy), molybdenum, tungsten, titanium, chromium, silver, gold, palladium, platinum, iron, manganese, zirconium, lead-tin alloys, silver-tin alloys, tin, lead, alloys thereof, or combinations thereof. It is appreciated the metal component can be formed by a variety of processes (e.g., physical vapor deposition (PVD), (e.g., sputter, evaporation, etc.), chemical vapor deposition, electro-chemical (e.g., electroplating, emersion plating, etc.), metal bonding, etc.). A metal component can be directly coupled to a device structure or indirectly coupled to the device structure. A metal component can be added directly on or over a device structure or indirectly over the device structure. In one embodiment, there can be an intervening layer between the metal component and the support device structure.

In block 1520 an optional adhesion layer can be formed over the metal layer. It is appreciated that more than one adhesive layer can be formed. In one example, the adhesion layer contains a pressure sensitive adhesive (PSA), such as an acrylic PSA laminate. In another example, the adhesion layer contains an ethylene/vinylacetate copolymer. An adhesion component can be directly coupled to a metal component or indirectly coupled to the metal component. An adhesion component can be added directly over a metal component or indirectly over the metal component. In one embodiment, there can be an intervening layer. In one embodiment, an additional intermediate or primer layer can be included to facilitate adhesion. In one exemplary implementation the primer layer is coupled to the non-metallic layer.

In block 1530 at least one non-metal layer coupled to the metal layer is formed. It is appreciated that more than one non-metal layer can be formed. The non-metal layer can be coupled directly to the metal layer or the non-metal layer can be indirectly coupled to the metal layer (e.g., by an intervening layer, an adhesion layer, etc.). In one embodiment, non-metal component 120 may be disposed or formed directly or indirectly on or over metal component 120. The non-metal layer can include at least one laminate support layer. The laminate support layer or the flexible support layer may contain a polymeric material, a co-polymeric material, or an oligomeric material. For example, the laminate support layer may contain polyethylene terephthalate polyester, polyethylene naphthalate, polyimide, or derivatives thereof. It is appreciated that the non-metal support component can have a variety of configurations (e.g., elements, thicknesses, etc.). In one embodiment, a laminate support layer may have a thickness within a range from about 25 μm to about 350 μm. In another embodiment the laminate support layer may have a thickness from about 50 μm to about 150 μm. The laminate support layer can be disposed on the adhesion layer or directly on the metallic support layer, wherein the laminate support layer contains a polymeric material, a co-polymeric material, or an oligomeric material, such as polyethylene terephthalate polyester, polyethylene naphthalate, polyimide, or derivatives thereof. In some embodiments, the laminate support layer disposed on or over the metallic support layer contains at least one flexible support layer disposed on or over at least one adhesion layer.

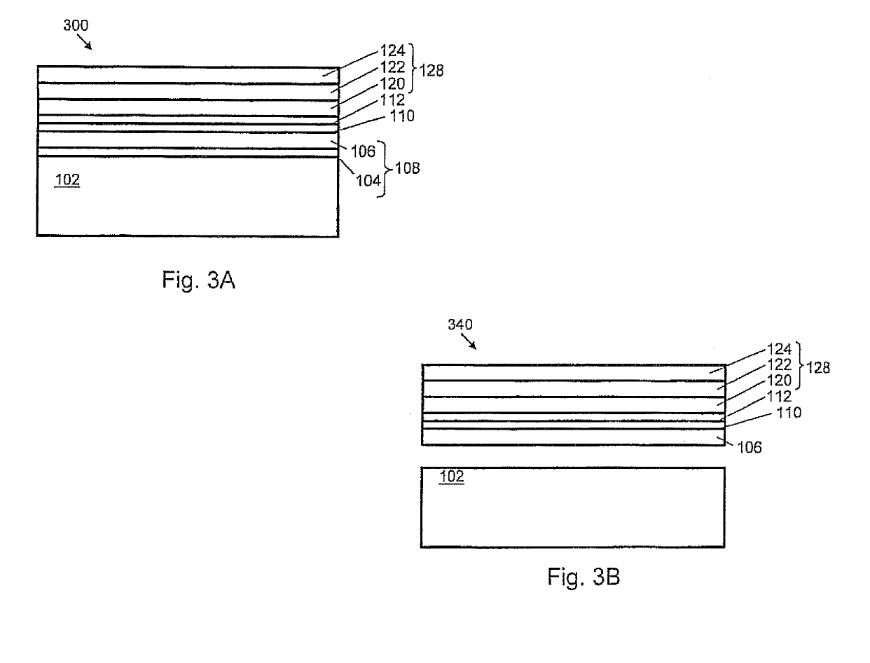

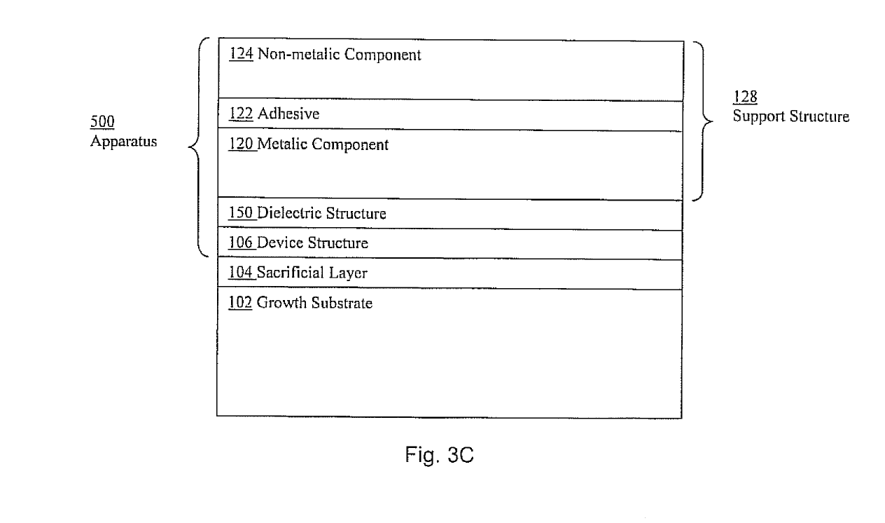

It is appreciated that optional additional components or layers can be formed. For example, at least one reflector component or layer can be formed. At least one barrier layer can be formed. At least one dielectric layer can be formed. In one embodiment, the dielectric is formed between the metal component and the device structure. FIG. 3C is a block diagram of exemplary apparatus 500 with a dielectric structure in accordance with one embodiment of the present invention. Dielectric structure 150 is formed between device structure 106 and metallic component 120. The dielectric can be patterned (e.g., with holes, vias, etc.) to enable electrical connectivity with a metal layer in the metal component. There can be an additional interconnect or corrosion capping layer formed on a side of the non-metal component away from the previously formed metal component. In one embodiment, there can be a non-metal sub-layer in between metal sub-layers of a metal component. In one embodiment, there can be a metal sub-layer in between non-metal sub layers of a non-metal component. It is also appreciated the metal components and non-metal components can be textured.

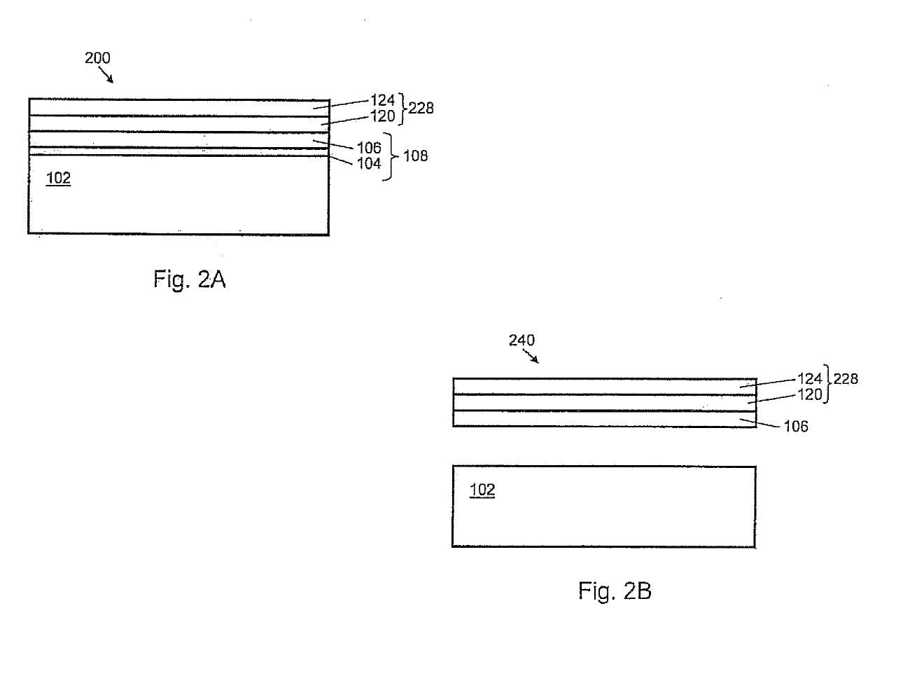

It is appreciated that an apparatus with a support structure can have a variety of configurations. FIG. 2A depicts substrate 200 containing ELO thin film stack 108 disposed on growth substrate 102, similar to another embodiment described herein. FIG. 2A further depicts support structure 228 disposed on or over device structure 106. Support structure 228 may contain non-metal component 124 disposed directly on metal component 120—without an adhesion layer. In some examples, non-metal component 124 may contain a flexible support layer formed, deposited, or otherwise adhered directly on metal component 120. Non-metal component 124 may be melted to, thermally adhered to, or pressed against metal component 120. Non-metal component 124 may be chemically treated, cured, or bonded to metal component 120.

In one embodiment, a thin film stack material is disposed on a substrate, such as growth substrate 102 and contains sacrificial layer 104 disposed on growth substrate 102, device structure 106 disposed on sacrificial layer 104, and support structure 228 disposed on or over device structure 106. Support structure 228 contains non-metal component 124 disposed on or over metal component 120. Support structure 228 provides resistance to cracking propagation, handling tension, bending radius, and bending forces. Support structure 228 may be under tension while device structure 106 is under compression. The ELO process includes removing sacrificial layer 104 during an etching process, while peeling device structure 106 from growth substrate 102 and forming an etch crevice there between until device structure 106 and support structure or film 228 are removed from growth substrate 102.

FIG. 2B depicts supported epitaxial film stack apparatus 240 pealed away from or otherwise separated from growth substrate 102 during the ELO process according to embodiments described herein.

FIG. 3A depicts substrate 300 containing ELO thin film stack 108 disposed on growth substrate 102, similar to another embodiment herein. ELO thin film stack 108 may have device structure 106 disposed on or over sacrificial layer 104, which is disposed on or over growth substrate 102. In some embodiments, reflector layer 110 may be disposed on or over device structure 106. Reflector layer 110 may be a single layer or contain multiple layers. Reflector layer 110 may contain at least one metal such as silver, copper, aluminum, gold, nickel, alloys thereof, or combinations thereof. In one example, reflector layer 110 contains silver or a silver alloy. In another example, reflector layer 110 is a metal containing contact layer. Reflector layer 110 may have a thickness within a variety of ranges. In a first embodiment reflector layer 110 may have a thickness from about 0.001 μm to about 10 μm. In a second embodiment reflector layer 110 may have a thickness from about 0.01 μm to about 0.1 μm. In a third embodiment reflector layer 110 may have a thickness from about 0.1 μm to about 0.3 μm. In a fourth embodiment reflector layer 110 may have a thickness about 0.2 μm. Reflector layer 110 may be deposited by a vapor deposition process, such as PVD, sputtering, electron beam deposition (e-beam), ALD, CVD, PE-ALD, or PE-CVD, or by other deposition processes including inkjet deposition, writing, evaporator, electroplating, electro-less chemical deposition (e-less), or combinations thereof.

In some embodiments, barrier layer 112 may be disposed on or over reflector layer 110. Barrier layer 112 may be a single layer or contain multiple layers. Barrier layer 112 may contain at least one metal such as nickel, copper, silver, nickel-copper alloys, nickel-cobalt alloys, alloys thereof, or combinations thereof. In one example, barrier layer 112 contains nickel or a nickel alloy. In another example, barrier layer 112 contains copper or a copper alloy. In another example, barrier layer 112 contains a nickel-copper alloy. Barrier layer 112 may have a thickness within a variety of ranges. In a first embodiment, barrier layer 112 may have a thickness from about 0.01 μm to about 2 μm. In a second embodiment, barrier layer 112 may have a thickness from about 0.05 μm to about 1 μm. In a third embodiment, barrier layer 112 may have a thickness from about 0.1 μm to about 0.5 μm. In a fourth embodiment, barrier layer 112 may have a thickness about 0.3 μm. Barrier layer 112 may be deposited by a vapor deposition process, such as PVD, sputtering, e-beam deposition, ALD, CVD, PE-ALD, or PE-CVD, or by other deposition processes including inkjet deposition, writing, evaporator, electroplating, e-less, or combinations thereof.

In one embodiment, a thin film stack material is disposed on a substrate, such as growth substrate 102 and contains sacrificial layer 104 disposed on growth substrate 102, device structure 106 disposed on sacrificial layer 104, and support structure 128 disposed on or over device structure 106. Support structure 128 contains non-metal component 124 disposed on or over metal component 120. Metal component 120 is disposed on or over barrier layer 112 and/or reflector layer 110. In one example, metal component 120 may be disposed directly on barrier layer 112. In another example, barrier layer 112 may be omitted and metal component 120 may be disposed directly on reflector layer 110. In other embodiments, other layers may be disposed between metal component 120 and non-metal component 124 or between device structure 106 and metal component 120. For example, FIG. 3A depicts adhesion layer 122 disposed between metal component 120 and non-metal component 124.

In some embodiments, support structure 128 includes metal component 120 and non-metal component 124. In other embodiments, support component 128 includes metal component 120, adhesion layer 122, and non-metal component 124. While reflector layer 110 and barrier layer 112 may provide some support of device structure 106, reflector layer 110 and barrier layer 112 can each be very thin relative to the thicknesses of metal component 120, adhesion layer 122, or non-metal component 124. Support film 128 provides resistance to cracking propagation, handling tension, bending radius, and bending forces. Support film 128 may be under tension while device structure 106 is under compression. The ELO process includes removing sacrificial layer 104 during an etching process, while peeling device structure 106 from growth substrate 102 and forming an etch crevice there between until device structure 106 and support structure 128 are removed from growth substrate 102. While reflector layer 110 and barrier layer 112 are described separately from support structure 128 in some embodiments, it is appreciated that in other embodiments, reflector layer 110 and barrier layer 112 can be considered included in support structure 128. It is also appreciated that other components of support structure 128 (e.g., metal component 120, non-metal component 124 etc.) can have reflective and barrier characteristics themselves.

FIG. 3B depicts supported epitaxial film stack apparatus 340 peeled away from or otherwise separated from growth substrate 102 during the ELO process according to embodiments described herein. Sacrificial layer 104 may be etched away or otherwise removed during an etching process, thereby freeing supported epitaxial film stack 340 from growth substrate 102. During the etching process, an etch crevice is formed between device structure 106 and growth substrate 102 and as the etching process proceeds, the crevice continues to increase in length and angle while sacrificial material is removed from sacrificial layer 104. Eventually, sacrificial layer 104 is completely or substantially completely removed and supported epitaxial film stack 340 is separated from growth substrate 102. In some embodiments, sacrificial layer 104 is generally exposed to a wet etch solution during the etching process. In one embodiment, the wet etch solution can contain hydrofluoric acid, and may further contain additives (e.g., a surfactant, a buffer, inhibitor, etc.).

It is appreciated that support structures (e.g., support structure 128) can include a variety of configurations. A metallic support layer can contain at least one metal, such as silver, nickel, copper, nickel-copper alloy, molybdenum, tungsten, cobalt, iron, manganese, alloys thereof, derivatives thereof, or combinations thereof. The metallic support layer may contain a single layer or multiple layers of the same or different metals. In one example, the metallic support layer contains a first nickel layer, a second nickel layer, and a copper layer disposed between the first and second nickel layers. In one embodiment, the metallic support layer may have a thickness within a range from about 1 μm to about 50 μm.

In many examples, the metallic support layer contains a nickel-copper alloy which may contain additional elements. The nickel-copper alloy may further contain iron and/or manganese. In some examples, the nickel-copper alloy may further contain carbon, silicon, or sulfur. The nickel-copper alloy may have a nickel concentration by weight within a range from about 63% to about 75%, preferably, from about 65% to about 70%, a copper concentration by weight within a range from about 28% to about 34%, preferably, from about 30% to about 32%, an iron concentration by weight within a range from about 2% to about 3%, and/or a manganese concentration by weight within a range from about 1% to about 3%. The nickel-copper alloy may also have a carbon concentration by weight within a range from about 0.1% to about 1%, a silicon concentration by weight within a range from about 0.1% to about 1%, and/or a sulfur concentration by weight within a range from about 0.01% to about 0.1%.

In one example, metal component 120 contains nickel or a nickel alloy. In another example, metal component 120 contains copper or a copper alloy. In other examples, metal component 120 contains a nickel-copper alloy, a nickel-molybdenum alloy, a nickel-cobalt alloy, an iron-nickel-cobalt alloy, a molybdenum-titanium alloy, or derivatives thereof. In some examples, metal component 120 contains a first nickel layer, a second nickel layer, and a copper layer disposed between the first and second nickel layers.

Metal component 120 may have a thickness within a variety of ranges. In a first embodiment, metal component 120 may have a thickness from about 1 μm to about 50 μm. In a second embodiment, metal component 120 may have a thickness from about 5 μm to 20 μm. In a third embodiment, metal component 120 may have a thickness from about 0.5 μm to about 500 μm. In a fourth embodiment, metal component 120 may have a thickness from about 1 μm to about 300 μm. In a fifth embodiment, metal component 120 may have a thickness from about 1 μm to about 200 μm. In a sixth embodiment, metal component 120 may have a thickness from about 1 μm to about 100 μm. In a seventh embodiment, metal component 120 may have a thickness from about 0.5 μm to about 40 μm. In an eight embodiment, metal component 120 may have a thickness from about 1 μm to about 20 μm. In a ninth embodiment, metal component 120 may have a thickness from about 1 μm to about 15 μm. In a tenth embodiment, metal component 120 may have a thickness from about 5 μm or about 10 μm. In an eleventh embodiment, metal component 120 may have a thickness from about 30 μm to about 150 μm. In a twelfth embodiment, metal component 120 may have a thickness from about 30 μm to about 150 μm. In a thirteenth embodiment, metal component 120 may have a thickness from about 40 μm to about 120 μm. In a fourteenth embodiment, metal component 120 may have a thickness from about 60 μm to about 100 μm. Each metal-containing layer of metal component 120 may be independently deposited by a vapor deposition process, such as PVD, sputtering, e-beam, ALD, CVD, PE-ALD, or PE-CVD, or by other deposition processes including evaporator, electroplating, e-less, or combinations thereof.

In some examples, metal component 120 contains a nickel-copper alloy. The nickel-copper alloy may contain additional elements besides nickel and copper, such as iron, manganese, chromium, silver, carbon, silicon, or sulfur. In some examples, the nickel-copper alloy may further contain iron and/or manganese. In other examples, the nickel-copper alloy may further contain carbon, silicon, or sulfur. The nickel-copper alloy may have a nickel concentration by weight within a range from about 63% to about 75%, preferably, from about 65% to about 70%. In some examples, the nickel-copper alloy may have a copper concentration by weight within a range from about 28% to about 34%, preferably, from about 30% to about 32%. The nickel-copper alloy may have an iron concentration by weight within a range from about 2% to about 3%. The nickel-copper alloy may have a manganese concentration by weight within a range from about 1% to about 3%. The nickel-copper alloy may have a carbon concentration by weight within a range from about 0.1% to about 1%. The nickel-copper alloy may have a silicon concentration by weight within a range from about 0.1% to about 1%. The nickel-copper alloy may have a sulfur concentration by weight within a range from about 0.01% to about 0.1%.

In some embodiment, metal component 120 contains multiple layers stacked or formed upon each other. In some examples, metal component 120 contains at least one layer of nickel and at least one layer of copper. In one example, metal component 120 contains at least one layer of copper disposed between a lower layer containing nickel and an upper layer containing nickel.

In another embodiment, metal component 120 may contain an iron alloy, such as an iron-nickel-cobalt alloy. In one example, the iron-nickel-cobalt alloy may be a commercially available alloy, such as KOVAR® alloy. The iron-nickel-cobalt alloy contains iron, nickel, cobalt, and may also contain at least one of element, such as manganese, silicon, or carbon. In one example, the iron-nickel-cobalt alloy contains up to about 29% of nickel, up to about 17% of cobalt, up to about 0.30% of manganese, up to about 0.20% of silicon, up to about 0.02% of carbon, and the remainder iron. In some examples, the iron-nickel-cobalt alloy may have an iron concentration within a range from about 45% to about 70%, preferably, from about 55% to about 60%, and up to about 29% of nickel, up to about 17% of cobalt, up to about 0.30% of manganese, up to about 0.20% of silicon, and up to about 0.02% of carbon.

In another embodiment, metal component 120 may contain a nickel-copper alloy. In several examples, the nickel-copper alloy may be a commercially available alloy, such as MONEL® 400 or 404 alloy (UNS N04400). The nickel-copper alloy contains nickel and copper and may also contain at least one of element, such as iron, manganese, carbon, silicon, or sulfur. In some examples, the nickel-copper alloy may have by weight a nickel concentration within a range from about 55% to about 75%, for example, about 66.5%, a copper concentration within a range from about 20% to about 40%, for example, about 31%, an iron concentration within a range from about 0.5% to about 5%, for example, about 2.5%, a manganese concentration within a range from about 0.5% to about 5%, for example, about 2%, a carbon concentration of less than 1%, for example, about 0.3%, a silicon concentration of less than 1%, for example, about 0.5%, and/or a sulfur concentration of less than 1%, for example, about 0.02%. In one example, a nickel-copper alloy contains by weight nickel (about 65% to about 70%), copper (about 20% to about 29%), iron (up to about 5%), and manganese (up to about 5%). In another example, a nickel-copper alloy contains by weight nickel (about 63% to about 75%), copper (about 28% to about 34%), iron (up to about 2.5%), manganese (up to about 2%), carbon (up to about 0.3%), silicon (up to about 0.5%), and sulfur (up to about 0.02%).

In another embodiment, metal component 120 may contain a nickel-molybdenum alloy. In one example, the nickel-molybdenum alloy may be a commercially available alloy, such as HASTELLOY® B-2 alloy. The nickel-molybdenum alloy contains nickel and molybdenum and may also contain at least one of element, such as iron, manganese, cobalt, chromium, carbon, silicon, phosphorus, or sulfur. In some examples, the nickel-molybdenum alloy may have a nickel concentration within a range from about 55% to about 75%, for example, about 67%, a molybdenum concentration within a range from about 15% to about 40%, for example, about 28%, an iron concentration within a range from about 0.5% to about 5%, for example, about 2%, a cobalt concentration within a range from about 0.2% to about 5%, for example, about 1%, a copper concentration within a range from about 0.2% to about 5%, for example, about 1%, a manganese concentration within a range from about 0.2% to about 5%, for example, about 1%, a carbon concentration of less than 0.5%, for example, about 0.02%, a phosphorus concentration of less than 0.5%, for example, about 0.03%, a silicon concentration of less than 05%, for example, about 0.1%, and/or a sulfur concentration of less than 0.5%, for example, about 0.01%.

In another embodiment, metal component 120 may contain a molybdenum-titanium alloy. In one example, the molybdenum-titanium alloy may be a commercially available alloy, such as TZM® alloy. The nickel-molybdenum alloy contains molybdenum and titanium and may also contain zirconium or other elements. In some examples, the molybdenum-titanium alloy may have a molybdenum concentration within a range from about 95% to about 99.7%, preferably, from about 97% to about 99.5%, for example, about 99%; a titanium concentration within a range from about 0.05% to about 5%, preferably, from about 0.1% to about 1%, or from about 0.4% to about 0.6%, for example, about 0.5%; a zirconium concentration within a range from about 0.005% to about 2%, preferably, from about 0.01% to about 1%, or from about 0.06% to about 0.12%, for example, about 0.1%.

Adhesion layer 122 may be disposed on or over metal component 120. Adhesion layer 122 may be a single layer or contain multiple layers. Adhesion layer 122 may contain an adhesive or a glue and may be a polymer, a copolymer, an oligomer, derivatives thereof, or combinations thereof. Embodiments provide adhesion layer 122 is compatible and stable at a wide range of temperatures, such as within a range from about −40° C. to about 300° C., and in some examples, from about −30° C. to about 150° C., or from about −20° C. to about 100° C.

In one embodiment, adhesion layer 122 contains a copolymer. In one example, the copolymer may be an ethylene/vinylacetate (EVA) copolymer or derivatives thereof. In other examples, adhesion layer 122 may contain a hot-melt adhesive, an organic material or organic coating, an inorganic material, or combinations thereof. Adhesion layer 122 may have a thickness within a variety of ranges. In a first embodiment, adhesion layer 122 may have a thickness from about 5 μm to about 500 μm. In a second embodiment, adhesion layer 122 may have a thickness from about 5 μm to about 120 μm. In a third embodiment, adhesion layer 122 may have a thickness from about 10 μm to about 80 μm. In a fourth embodiment, adhesion layer 122 may have a thickness from about 20 μm to about 40 μm. In a fifth embodiment, adhesion layer 122 may have a thickness of about 30 μm.

In another embodiment, adhesion layer 122 may contain an elastomer, such as rubber, foam, or derivatives thereof. Alternatively, adhesion layer 122 may contain a material such as neoprene, latex, or derivatives thereof. Adhesion layer 122 may contain a monomer. For example, adhesion layer 122 may contain an ethylene propylene diene monomer or derivatives thereof.

In other embodiments, adhesion layer 122 may contain or be attached by a pressure sensitive adhesive (PSA), an acrylic PSA, or other adhesive laminate. In some examples, adhesion layer 122 may be a PSA which is a laminate containing polyvinyl, polycarbonate, polyester, derivatives thereof, or combinations thereof. It is appreciated that adhesion layer 122 may contain PSA laminate layers which have various thicknesses. In some examples, adhesion layer 122 may contain a PSA laminate which has a thickness within a range from about 25 μm to about 500 μm. In some examples, adhesion layer 122 may have a thickness from about 75 μm to about 250 μm.

In an alternative embodiment, adhesion layer 122 may contain an optical adhesive or an UV-curable adhesive when bonding or adhering non-metal component 124 to metal component 120. Examples provide that the optical or UV-curable adhesive contains n-butyl n-octyl phthalate, tetrahydrofurfuryl methacrylate, acrylate monomer, derivatives thereof, or combinations thereof. The curable adhesive may be applied to metal component 120 and non-metal component 124 or a flexible support layer may be disposed thereover. A UV-light source may be shined through non-metal component 124 in order to cure the adhesive and form adhesion layer 122. Generally, the adhesive may be exposed to the UV radiation for a time period within a range from about 1 minute to about 10 minutes, preferably, from about 3 minutes to about 7 minutes, such as about 5 minutes. The adhesive may be cured at a temperature within a range from about 25° C. to about 75° C., such as about 50° C. Adhesion layer 122 may be formed from or contain an optical adhesive and/or a UV curable adhesive.

Non-metal component 124 is generally a flexible layer and may be disposed on or over adhesion layer 122. Non-metal component 124 may be a single layer or film or may contain multiple layers or films. Non-metal component 124 generally contains at least one flexible material, such as plastic or rubber. The flexible material may be in the form of a film or a sheet and may be a polymer, a copolymer, an oligomer, derivatives thereof, or combinations thereof. Non-metal component 124 may contain at least one material, such as polyester, polyimide, polyethylene, polypropylene, polyimide, polyolefin, polyacrylic, derivatives thereof, or combinations thereof. Examples of some specific materials that non-metal component 124 may contain include polyethylene terephthalate polyester, polyethylene naphthalate (PEN) polyester, polyimide, derivatives thereof, or combinations thereof.

In some examples, non-metal component 124 contains a polyester compound or a polyester derivative. In some examples, non-metal component 124 may contain polyethylene terephthalate polyester, such as a MYLAR polymeric film, or a derivative of polyethylene terephthalate polyester. In other examples, non-metal component 124 may contain a polymeric film of PEN polyester or a derivative of PEN polyester. In other examples, non-metal component 124 may contain a polyimide laminate, such as a polyester polyimide or a derivative of polyester polyimide.

Non metal component 124 may have a thickness within a variety of ranges. In a first embodiment, non-metal component 124 may have a thickness from about 25 μm to about 500 μm. In a second embodiment, non-metal component 124 may have a thickness from about 25 μm to about 350 μm. In a third embodiment, non-metal component 124 may have a thickness from about 50 μm to about 150 μm. In a forth embodiment, non-metal component 124 may have a thickness from about 50 μm to about 250 μm. In a fifth embodiment, non-metal component 124 may have a thickness of about 50 μm. In a sixth embodiment, non-metal component 124 may have a thickness of about 60 μm. In a seventh embodiment, non-metal component 124 may have a thickness of about 100 μm. In an eight embodiment, non-metal component 124 may have a thickness of about 125 μm. In a ninth embodiment, non-metal component 124 may have a thickness of about 200 μm. In a tenth embodiment, non-metal component 124 may have a thickness of about 250 μm.

In some embodiments, sacrificial layer 104 may contain aluminum arsenide, alloys thereof, derivatives thereof, or combinations thereof. In one example, sacrificial layer 104 contains an aluminum arsenide layer. It is appreciated sacrificial layer 104 may have a thickness within a variety of ranges. In a first embodiment, sacrificial layer 104 may have a range of about 1 μm or less. In a second embodiment, sacrificial layer 104 may have a range from about 0.001 μm to about 0.01 μm. In a third embodiment, sacrificial layer 104 may have a range from about 0.01 μm to about 0.1 μm. Growth substrate 102 may be a wafer or a growth substrate and usually contains gallium arsenide, gallium arsenide alloys or other derivatives, and may be n-doped, p-doped, un-doped, semi-insulating, etc.

Device structure 106 usually contains a plurality of layers containing Groups III/V epitaxially-grown materials, which may be used as photovoltaic devices (e.g., solar cells), solar conversion devices, optical devices, photonic devices, mechanical devices, semiconductor devices, electronic devices, opto-electric devices, or other devices. In some embodiments, device structure 106 may contain gallium arsenide, aluminum gallium arsenide, indium aluminum gallium phosphide, indium gallium phosphide, indium aluminum phosphide, alloys thereof, derivatives thereof, or combinations thereof. Device structure 106 may contain one layer of material, but generally contains multiple layers. The overall thickness of device structure 106, including the sum of all layer thicknesses within the stack, may be within a range from about 0.5 μm to about 5 μm, such as from about 1 μm to about 2 μm.

In some examples, device structure 106 has at least a layer containing gallium arsenide and another layer containing aluminum gallium arsenide or indium aluminum gallium phosphide. In another example, device structure 106 contains an aluminum gallium arsenide or indium aluminum gallium phosphide passivation layer, a gallium arsenide active layer, and an optional second aluminum gallium arsenide or indium aluminum gallium phosphide passivation layer, respectively disposed on each other. The aluminum gallium arsenide or indium aluminum gallium phosphide passivation layer may have a thickness within a variety of ranges. In one embodiment, the aluminum gallium arsenide or indium aluminum gallium phosphide passivation layer has a thickness from about 0.01 μm to about 1 μm. In one embodiment, the aluminum gallium arsenide or indium aluminum gallium phosphide passivation layer has a thickness of about 0.01 μm to about 0.1 μm. In one embodiment, aluminum gallium arsenide or indium aluminum gallium phosphide passivation layer has a thickness of about 0.1 μm to about 1 μm. In one embodiment, the gallium arsenide active layer may have a thickness within a variety of ranges. In one embodiment, the gallium arsenide active layer may have a thickness from about 0.5 μm to about 4 μm. In one embodiment, the gallium arsenide active layer may have a thickness from about 1 μm to about 2 μm. In one embodiment, the gallium arsenide active layer may have a thickness from of about 2 μm. In some examples, device structure 106 further contains a second aluminum gallium arsenide or indium aluminum gallium phosphide passivation layer. The second gallium arsenide passivation layer may have a thickness within a range from about 0.01 μm to about 1 μm. In one embodiment, second gallium arsenide passivation layer has a thickness of about 0.01 μm to about 0.1 μm. In one embodiment, second gallium arsenide passivation layer has a thickness of about 0.1 μm to about 1 μm. It is appreciated that indium aluminum gallium phosphide can be replaced with indium gallium phosphide or indium aluminum phosphide or derivatives thereof, combinations thereof, or alloys thereof in some of the embodiments described herein.

In other embodiments herein, device structure 106 may have a cell structure containing multiple layers. The cell structure may contain gallium arsenide, n-doped gallium arsenide, p-doped gallium arsenide, aluminum gallium arsenide, indium aluminum gallium phosphide, n-doped aluminum gallium arsenide, p-doped aluminum gallium arsenide, indium gallium phosphide, alloys thereof, derivatives thereof, or combinations thereof.

Descriptions of some exemplary support structure examples are set forth in following sections. The following exemplary support structure descriptions include configuration indications (e.g., elements, thickness, etc.) that are some of the possible configuration characteristics that a present metal support component can have. It is appreciated that other exemplary embodiments can have different values. For example, some of the following descriptions indicate a metal support layer thickness of about 5 μm and some of the following descriptions indicate a metal support layer thickness of about 10 μm. It is appreciated that other exemplary embodiments can have different metal support layer values (e.g., about 1 μm to about 50 μm, etc.). Some of the following exemplary descriptions indicate a laminated support layer thickness of about 100 μm and some of the following descriptions indicate a metal support layer thickness of about 250 μm. It is appreciated that other exemplary embodiments can have different laminated support layer values (e.g., about 25 μm to about 500 μm, etc.).

For Examples 1-29, an ELO substrate of about 100 mm×about 100 mm is used and contained a GaAs growth substrate, a sacrificial layer disposed on the growth substrate, a device component including an epitaxial film stack disposed on the sacrificial layer, and a support component including a support film disposed on the epitaxial film stack. A metal component of a support structure includes at lease one metallic support layer and a non-metal component of the support structure includes at least one laminated support layer.

### EXAMPLE 1

The support structure contains a metallic support layer of copper foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 60 μm).

### EXAMPLE 2

The support structure contains a metallic support layer of copper foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 100 μm).

### EXAMPLE 3

The support structure contains a metallic support layer of copper foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 200 μm).

### EXAMPLE 4

The support structure contains a metallic support layer of nickel foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 60 μm).

### EXAMPLE 5

The support structure contains a metallic support layer of nickel foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 100 μm).

### EXAMPLE 6

The support structure contains a metallic support layer of nickel foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 200 μm).

### EXAMPLE 7

The support structure contains a metallic support layer of nickel-copper alloy foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 100 μm).

### EXAMPLE 8

The support structure contains a metallic support layer of nickel-copper alloy foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 200 μm).

### EXAMPLE 9

The support structure contains a metallic support layer of molybdenum foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 100 μm).

### EXAMPLE 10

The support structure contains a metallic support layer of molybdenum foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 200 μm).

### EXAMPLE 11

The support structure contains a metallic support layer of tungsten foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 100 μm).

### EXAMPLE 12

The support structure contains a metallic support layer of tungsten foil (e.g., thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 200 μm).

### EXAMPLE 13

The support structure contains a metallic support layer of lead-tin alloy solder (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 125 μm).

### EXAMPLE 14

The support structure contains a metallic support layer of lead-tin alloy solder (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 250 μm).

### EXAMPLE 15

The support structure contains a metallic support layer of copper solder (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 125 μm).

### EXAMPLE 16

The support structure contains a metallic support layer of copper solder (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 250 μm).

### EXAMPLE 17

The support structure contains a metallic support layer of nickel-copper solder (e.g., MONEL® 404 alloy) (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 125 μm).

### EXAMPLE 18

The support structure contains a metallic support layer of nickel-copper solder (e.g., MONEL® 404 alloy) (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 250 μm).

### EXAMPLE 19

The support structure contains a metallic support layer of Ni/Cu/Ni laminate (e.g., each metal layer thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 125 μm).

### EXAMPLE 20

The support film contains a metallic support layer of Ni/Cu/Ni laminate (e.g., each metal layer thickness of about 5 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 250 μm).

### EXAMPLE 21

The support structure contains a metallic support layer of nickel-cobalt alloy foil (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 125 μm).

### EXAMPLE 22

The support structure contains a metallic support layer of nickel-cobalt alloy foil (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 250 μm).

### EXAMPLE 23

The support structure contains a metallic support layer of iron-nickel-cobalt alloy (e.g., KOVAR® Fe—Ni—Co alloy) (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 125 μm).

### EXAMPLE 24

The support structure contains a metallic support layer of iron-nickel-cobalt alloy (e.g., KOVAR® Fe—Ni—Co alloy) (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 250 μm).

### EXAMPLE 25

The support structure contains a metallic support layer of nickel-molybdenum alloy (e.g., HASTELLOy® B2 Ni—Mo alloy) (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 125 μm).

### EXAMPLE 26

The support structure contains a metallic support layer of nickel-molybdenum alloy (e.g., HASTELLOy® B2 Ni—Mo alloy) (e.g., thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 250 μm).

### EXAMPLE 27

The support structure contains a metallic support layer of molybdenum-titanium alloy (e.g., TZM® Mo—Ti alloy) (thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 125 μm).

### EXAMPLE 28

The support structure contains a metallic support layer of molybdenum-titanium alloy (e.g., TZM® Mo—Ti alloy) (thickness of about 10 μm) disposed on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 250 μm).

### EXAMPLE 29

The support structure contained a metallic support layer of electroless Ni—P (e.g., thickness of about 4 μm) deposited directly on the device structure, an adhesion layer containing an acrylic PSA (e.g., thickness of about 40 μm) or a layer of EVA (e.g., thickness of about 30 μm) disposed on the metallic support layer, and a laminated support layer deposited containing a polyethylene terephthalate polyester (e.g., thickness of about 60 μm).

External stress, such as the tension from handling, can cause excessive strain in an epitaxial film stack, such as a solar film, that leads to film cracking, therefore a strain-stress relationship exists for the epitaxial film stack. An increase of external lateral tension results in a change of strain in the solar film toward tensile direction.

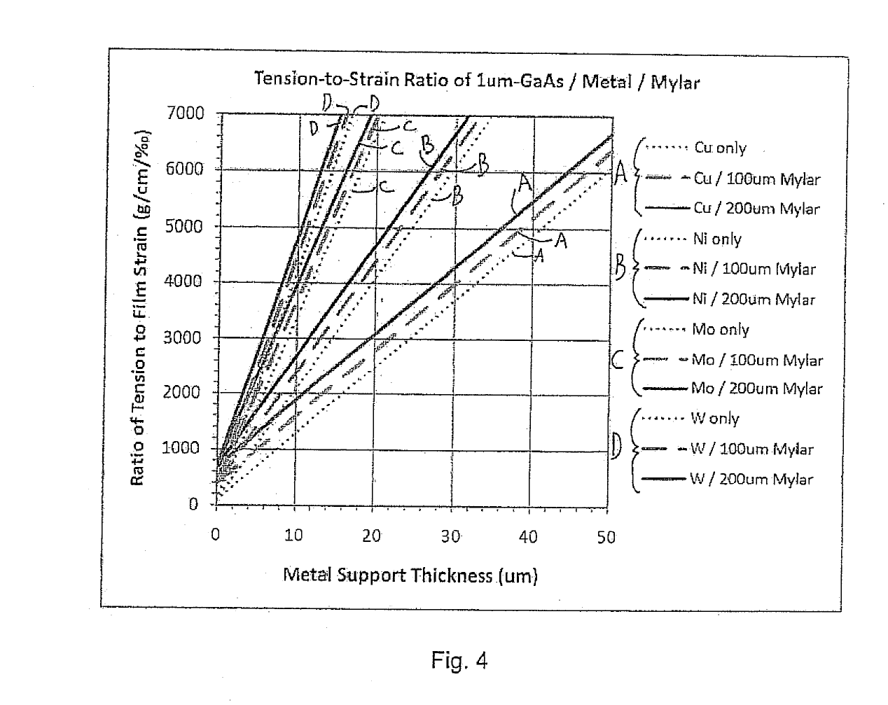

FIG. 4 is a graph illustrating tension-to-strain ratios of varying thicknesses of support layers. Due to the much higher stiffness of metal compared to a laminated support layer containing a polyethylene terephthalate polyester film (e.g., MYLAR® polymeric film), the tension tolerance of the composite laminate is rapidly improved with increasing metal thickness. An order of magnitude increase in tension tolerance can be achieved with just a few microns of metal in some examples.

Another source of lateral strain is the deformation of the laminate material due to its dimensional instability such as hygroscopic expansion or thermal strain relief. The resulting change of strain in the solar film must balance the change of the strain of the laminate.

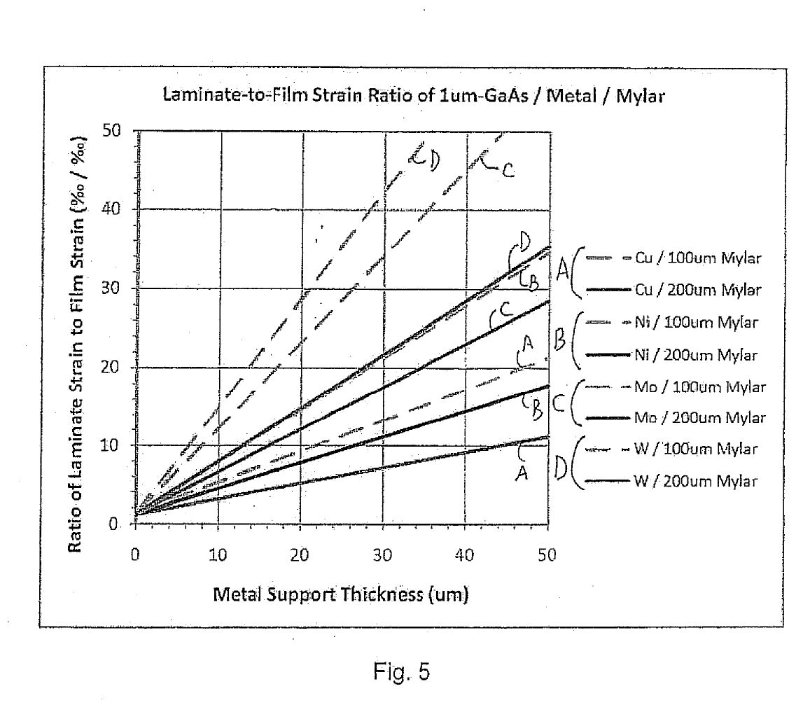

FIG. 5 is a graph illustrating laminate-to-film ratios of varying thicknesses of support layers. The strain of the composite laminate is highest for a laminated support layer containing a polyethylene terephthalate polyester film (e.g., MYLAR polymeric film) without containing a metallic support layer, with a laminate-to-film strain ratio near unity. The film strain can be quickly reduced with increasing thickness of the metallic support layer, again with an order-of-magnitude improvement a thickness of the metallic support layer within a range from about 1 μm to about 10 μm, or from about 2 μm to about 5 μm.

The bending of the epitaxial film stack useful since it is desirable to be able to curl without cracking the epitaxial film stack, both during ELO and for subsequent handling. At the same time, it is also desirable that the epitaxial film stack be able to withstand bending forces during handling without creating excess strain in the film that may lead to cracks. When the epitaxial film stack is bent to a radius of curvature without tension, the neutral plane must satisfy the absence of tension.

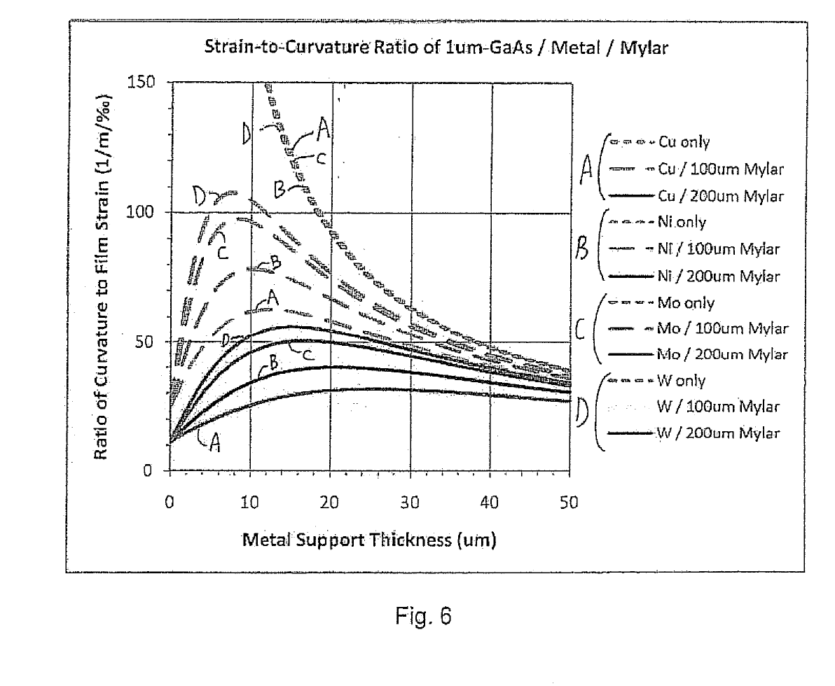

FIG. 6 is a graph illustrating strain-to-curvature ratios of varying thicknesses of support layers. In some embodiments, a maximum curvature may be achieved for a given limit of film strain for a thickness of the metallic support layer (e.g., from about 1 μm to about 50 μm). For a laminated support layer without a metallic support layer, the neutral plane of bending is near the middle of the laminate far away from the epitaxial film stack, hence tolerance to bending is limited. As the thickness of the metallic support layer is increased, the neutral plane quickly moves toward the center of the metallic support layer due to its much higher stiffness. Since this neutral plane is much closer to the epitaxial film stack, tolerance to bending is quickly improved. However, when the metallic support layer becomes very thick, the neutral plane at the middle of the metallic support layer again becomes far away from the epitaxial film stack, thus the tolerance to bending is reduced again. The bending moment, represents the torque of the bending.

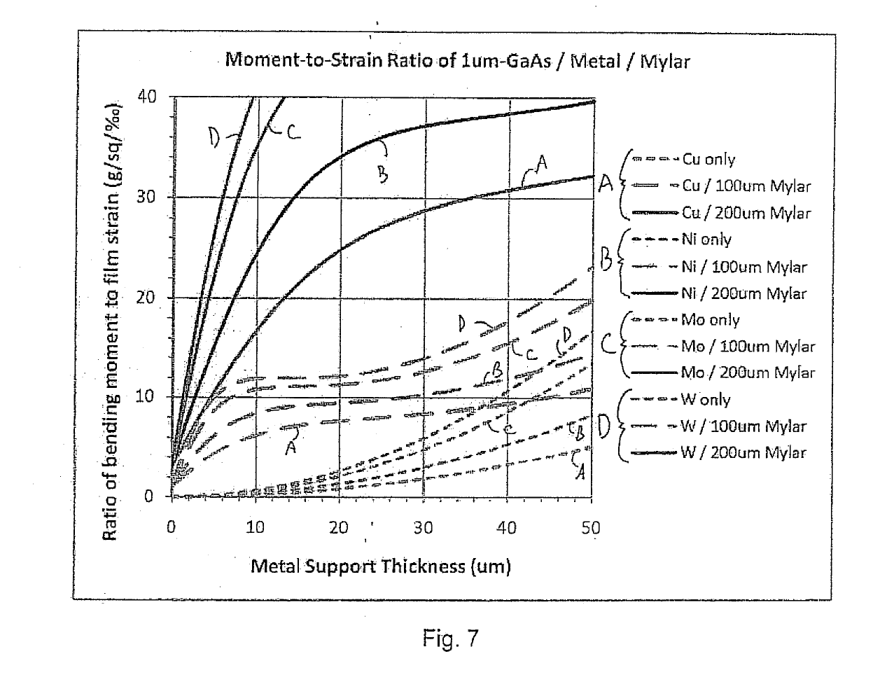

FIG. 7 is a graph illustrating moment-to-strain ratios of varying thicknesses of support layers. It is interesting to note that the addition of metal (e.g., a metallic support layer) quickly improves tolerance to bending moments, and then goes through a plateau after a few microns of metal (e.g., a thicker metallic support layer), and finally increases significantly again when the thickness of the metallic support layer becomes comparable to the laminate support layer thickness.

In some embodiments, the thickness of the metallic support layer may be within a range from about 1 μm to about 50 μm, or preferably from about 5 μm to about 20 μm and the laminate support layer thickness may be within a range from about 25 μm to about 350 μm or preferably from about 50 μm to about 150 μm, in order to obtain favorable bending radius and bending moment when compared to either metal layers alone or laminate layers alone.

Some embodiments include methods for forming an apparatus. The following are some exemplary concepts describing various implementations of a method for forming an apparatus.

Concept 1. A method for forming an apparatus or a thin film stack material including or during an epitaxial lift off process, comprising:
forming a device component or epitaxial film stack over a sacrificial layer on a growth substrate or wafer;
forming a support component or support film onto the device component or epitaxial film stack, wherein the support component or support film comprises:
   a metallic support component or metallic support layer disposed on the device component or epitaxial film stack; and
   a non-metallic support component or non-metallic support layer disposed on the metallic support component or metallic support layer;
removing the sacrificial layer during an etching process; and
peeling the device component or epitaxial film stack from the growth substrate or wafer while forming an etch crevice there between.

Concept 2. A method for forming an apparatus or a thin film stack material including or during an epitaxial lift off process, comprising:
forming a device component or epitaxial film stack over a sacrificial layer on a growth substrate or wafer;
forming a support component or support film onto the device component or epitaxial film stack, wherein the support component or support film comprises:
   a metallic support component or metallic support layer disposed on the device component or epitaxial film stack; and
   a non-metallic support component or non-metallic support layer disposed on the metallic support component or metallic support layer; and
removing the sacrificial layer during an etching process while separating the device component or epitaxial film stack from the growth substrate or wafer.

Concept 3. A method for forming an apparatus or a thin film stack material including or during an epitaxial lift off process, comprising:
forming a device component or epitaxial film stack over a sacrificial layer on a growth substrate or wafer;
forming a support component or support film onto the device component or epitaxial film stack, wherein the support component or support film comprises:
   a metallic support component or metallic support layer disposed on the device component or epitaxial film stack, wherein the metallic support component or metallic support layer comprises nickel and copper; and
   a non-metallic support component or non-metallic support layer disposed on the metallic support component or metallic support layer; and
removing the sacrificial layer during an etching process while separating the device component or epitaxial film stack from the growth substrate or wafer.

Concept 4. A method for forming an apparatus or a thin film stack material including or during an epitaxial lift off process, comprising:
forming a device component or epitaxial film stack over a sacrificial layer on a growth substrate or wafer;
forming a support component or support film onto the epitaxial film stack, wherein the support component or support film comprises:
   a metallic support component or metallic support layer disposed on the device component or epitaxial film stack, wherein the metallic support component or metallic support layer comprises nickel and copper; and
   a non-metallic support component or non-metallic support layer disposed on the metallic support component or metallic support layer, wherein the non-metallic support component or non-metallic support layer comprises a polymeric material, a co-polymeric material, or an oligomeric material; and
removing the sacrificial layer during an etching process while separating the device component or epitaxial film stack from the growth substrate or wafer.

Concept 5. A method for forming an apparatus or thin film stack material including or during an epitaxial lift off process, comprising:
forming a device component or epitaxial film stack over a sacrificial layer on a growth substrate or wafer;
forming a support component or support film onto the device component or epitaxial film stack, wherein the support component or support film comprises:
   a metallic support component or metallic support layer disposed on the device component or epitaxial film stack, wherein the metallic support component or metallic support layer comprises nickel and copper; and
   a non-metallic support component or non-metallic support layer disposed on the metallic support component or metallic support layer, wherein the non-metallic support component or non-metallic support layer comprises polyethylene terephthalate polyester or derivatives thereof; and
removing the sacrificial layer during an etching process while separating the device component or epitaxial film stack from the growth substrate or wafer.

Concept 6. The method as in any of concepts 1-5, further comprising maintaining compression within the device component or epitaxial film stack during the etching process.

Concept 7. The method as in any of concepts 1-5, wherein the non-metallic support component or non-metallic support layer comprises at least one flexible support layer disposed on at least one adhesion layer.

Concept 8. The method of concept 7, wherein the at least one adhesion layer comprises an adhesive.

Concept 9. The method of concept 8, wherein the adhesive is a pressure sensitive adhesive.

Concept 10. The method of concept 9, wherein the pressure sensitive adhesive is an acrylic pressure sensitive adhesive laminate.

Concept 11. The method of concept 8, wherein the adhesive comprises a copolymer.

Concept 12. The method of concept 11, wherein the adhesive comprises ethylene/vinylacetate.

Concept 13. The method as in any of concepts 1-5, wherein the non-metallic support component or non-metallic support layer comprises a flexible support layer disposed over an adhesion layer.

Concept 14. The method of concept 13, wherein the adhesion layer is disposed between the flexible support layer and the metallic support component or metallic support layer.

Concept 15. The method as in any of concepts 1-3, wherein the non-metallic support component or non-metallic support layer comprises a polymeric material, a co-polymeric material, or an oligomeric material.

Concept 16. The method as in any of concepts 1-4, wherein the non-metallic support component or non-metallic support layer comprises polyethylene terephthalate polyester or derivatives thereof.

Concept 17. The method as in any of concepts 1-5, wherein the non-metallic support component or non-metallic support layer has a thickness within a range from about 25 μm to about 500 μm.

Concept 18. The method of concept 17, wherein the thickness is within a range from about 50 μm to about 50 μm.

Concept 19. The method as in any of concepts 1-2, wherein the metallic support component or metallic support layer comprises nickel or copper.

Concept 20. The method as in any of concepts 1-5, wherein the metallic support component or metallic support layer comprises a metal selected from the group consisting of silver, nickel, copper, molybdenum, tungsten, alloys thereof, derivatives thereof, and combinations thereof.

Concept 21. The method as in any of concepts 1-5, wherein the metallic support component or metallic support layer comprises a nickel-copper alloy.

Concept 22. The method of concept 21, wherein the nickel-copper alloy comprises nickel, copper, and iron.

Concept 23. The method of concept 22, wherein the nickel-copper alloy further comprises manganese.

Concept 24. The method of concept 23, wherein the nickel-copper alloy further comprises carbon, silicon, or sulfur.

Concept 25. The method of concept 23, wherein the nickel-copper alloy further comprises carbon, silicon, and sulfur.

Concept 26. The method of concept 21, wherein the nickel-copper alloy comprises a nickel concentration by weight within a range from about 63% to about 75%.

Concept 27. The method of concept 26, wherein the nickel concentration is within a range from about 65% to about 70%.

Concept 28. The method of concept 26, wherein the nickel-copper alloy comprises a copper concentration by weight within a range from about 28% to about 34%.

Concept 29. The method of concept 28, wherein the copper concentration is within a range from about 30% to about 32%.

Concept 30. The method of concept 28, wherein the nickel-copper alloy comprises an iron concentration by weight within a range from about 2% to about 3%.

Concept 31. The method of concept 28, wherein the nickel-copper alloy comprises a manganese concentration by weight within a range from about 1% to about 3%.

Concept 32. The method of concept 28, wherein the nickel-copper alloy comprises a carbon concentration by weight within a range from about 0.1% to about 1%.

Concept 33. The method of concept 28, wherein the nickel-copper alloy comprises a silicon concentration by weight within a range from about 0.1% to about 1%.

Concept 34. The method of concept 28, wherein the nickel-copper alloy comprises a sulfur concentration by weight within a range from about 0.01% to about 0.1%.

Concept 35. The method as in any of concepts 1-5, wherein the metallic support component or metallic support layer comprises multiple layers of a metal selected from the group consisting of silver, nickel, copper, molybdenum, tungsten, cobalt, iron, manganese, alloys thereof, derivatives thereof, and combinations thereof.

Concept 36. The method of concept 35, wherein the metallic support component or metallic support layer comprises a first nickel layer, a second nickel layer, and a copper layer disposed between the first and second nickel layers.

Concept 37. The method as in any of concepts 1-5, wherein the metallic support component or metallic support layer has a thickness within a range from about 0.5 μm to about 500 μm.

Concept 38. The method of concept 37, wherein the thickness is within a range from about 5 μm to about 20 μm.

Concept 39. The method as in any of concepts 1-5, wherein the device component or epitaxial film stack comprises a material selected from the group consisting of gallium arsenide, aluminum gallium arsenide, indium gallium phosphide, indium aluminum gallium phosphide, indium aluminum phosphide, indium gallium phosphide, alloys thereof, derivatives thereof, and combinations thereof.

Concept 40. The method of concept 39, wherein the device component or epitaxial film stack has a thickness within a range from about 0.5 μm to about 5 μm.

Concept 41. The method of concept 40, wherein the thickness is within a range from about 1 μm to about 2 μm.

Concept 42. The method as in any of concepts 1-5, wherein the device component or epitaxial film stack comprises a cell structure containing multiple layers comprising at least one material selected from the group consisting of gallium arsenide, n-doped gallium arsenide, p-doped gallium arsenide, aluminum gallium arsenide, n-doped aluminum gallium arsenide, p-doped aluminum gallium arsenide, indium aluminum gallium phosphide, n-doped indium aluminum gallium phosphide, p-doped indium aluminum gallium phosphide, indium gallium phosphide, n-doped indium gallium phosphide, p-doped indium gallium phosphide, indium aluminum phosphide, n-doped indium aluminum phosphide, p-doped indium aluminum phosphide, alloys thereof, derivatives thereof, and combinations thereof.

Concept 43. The method as in any of concepts 1-5, wherein the sacrificial layer is exposed to a wet etch solution during the etching process, the wet etch solution comprises hydrofluoric acid, a surfactant, and a buffer.

Concept 44. The method as in any of concepts 1-5, wherein the sacrificial layer is etched at a rate of about 5 mm/hr or greater.

Concept 45. The method as in any of concepts 1-5, wherein the growth substrate or wafer comprises gallium arsenide or a gallium arsenide alloy.

Concept 46. The method as in any of concepts 1-5, wherein the sacrificial layer comprises aluminum arsenide, gallium aluminum arsenide, derivatives thereof, alloys thereof, or combinations thereof.

Concept 47. The method as in any of concepts 1-5, further comprising depositing the metallic support component or metallic support layer on the device component or epitaxial film stack.

Concept 48. The method as in any of concepts 1-5, wherein the metallic support component or metallic support layer is deposited by a vapor deposition process.

Concept 49. The method of concept 48, wherein the vapor deposition process is selected from the group consisting of PVD, sputtering, ebeam deposition, ALD, CVD, PE-ALD, and PE-CVD.

Concept 50. The method as in any of concepts 1-5, further comprising bonding or adhering the non-metallic support component or non-metallic support layer on the metallic support component or metallic support layer.

Concept 51. The method of concept 50, wherein the non-metallic support component or non-metallic support layer is bonded or adhered to the metallic support component or metallic support layer by an adhesive.

Concept 52. The method as in any of concepts 1-5, wherein the non-metallic support component or non-metallic support layer comprises at least one flexible support layer disposed over at least one adhesion layer.

Concept 53. The method of concept 52, wherein the at least one adhesion layer comprises an acrylic pressure sensitive adhesive laminate.

Concept 54. The method of concept 52, wherein the at least one adhesion layer comprises an ethylene/vinylacetate copolymer adhesive.

Thus, present apparatuses and processes facilitate efficient and effective fabrication and utilization of thin film devices. Support structures of present apparatuses and processes supplement features of the device structure. The device structure and support structure can be configured in layers. It is appreciated there are a variety of ways in which the support structure can supplement (e.g., add to, enhance, aid, increase, etc.) features (e.g., functions, characteristics, etc.) of a device. A support structure can add and enhance structural and mechanical integrity (e.g., reduce susceptibility to cracking, breaking, etc.) while also aiding functional operations (e.g., increasing optical reflection, improving thermal conductivity, establishing electrical connectivity between components, etc.).

The foregoing descriptions of specific embodiments have been presented for purposes of illustration and description. They are not intended to be exhaustive or to limit the invention to the precise forms disclosed, and many modifications and variations are possible in light of the above teaching. The embodiments were chosen and described in order to best explain the principles and its practical application, to thereby enable others skilled in the art to best utilize the invention and various embodiments with various modifications as are suited to the particular use contemplated. It is intended that the scope be defined by the Claims appended hereto and their equivalents.

What is claimed is

1) An apparatus comprising:
a device structure including portions of an electronic device;
a support structure coupled to said device structure; wherein said support structure supplements features of said device structure and said support structure includes:
a metal component coupled to said device structure; and
a non-metal component coupled to said metal component.

2. The apparatus of claim 1 wherein said support component supplements structural and mechanical integrity of said device structure.

3) The apparatus of claim 1 wherein said support component supplement functional operations of said device structure.

4) The apparatus of claim 1 wherein said metal component includes at least one layer of metal material.

5) The apparatus of claim 1 wherein said non-metal component includes at least one layer of non metal material.

6) The apparatus of claim 1 wherein said non-metal component includes a polymeric material.

7) The apparatus of claim 1 wherein said metal component has greater stiffness characteristics with respect to said device structure.

8) The apparatus of claim 1 wherein said non-metal component has greater flexibility characteristics with respect to said metal layer component.

9) The apparatus of claim 1 wherein said support structure is configured to reflect light towards said device structure.

10) The apparatus of claim 1 wherein said support structure is configured to conduct electricity from said device structure.

11) A thin film apparatus fabrication method comprising:
adding a sacrificial layer on a growth substrate;
depositing a thin film device layer on said sacrificial layer;
performing a support structure formation process to form a support structure on said thin film device layer, and
removing said sacrificial layer.

12) in film apparatus fabrication method of claim 11 wherein said support structure formation process comprises:
forming at least one metal layer coupled to said thin film device layer; and
forming at least one non-metal layer coupled to said metal layer.

13) in film apparatus fabrication method of claim 12 wherein said support structure formation process further comprises forming at least one adhesive layer coupled to said metal layer and to said non-metal layer.

14) in film apparatus fabrication method of claim 11 wherein said metal component includes cooper.

15) in film apparatus fabrication method of claim 11 wherein said metal component includes nickel.

16) in film apparatus fabrication method of claim 11 wherein said non-metal component includes a polymeric material.

17) in film apparatus fabrication method of claim 11 wherein said non-metal component includes a co-polymeric material.

18) in film apparatus fabrication method of claim 11 wherein said metal component includes a silver material.

19) in film apparatus fabrication method of claim 11 wherein said non-metal component includes an oligomeric material.

20) A thin film support structure comprising:
a metal component configured to increase stiffness of a thin film device structure, said metal component coupled to said device structure;
a non-metal component configured to increase flexibility of said thin film device structure; and
an adhesive component configured to enhance coupling of said non-metal component to said metal component.

21) apparatus of claim 20 wherein said support component supplements structural and mechanical integrity of said device structure.

22) apparatus of claim 20 wherein said support component supplement functional operations of said device structure.

23) apparatus of claim 20 wherein said metal component includes at least one layer of metal material.

24) apparatus of claim 20 wherein said non-metal component includes at least one layer of non-metal material.

25) apparatus of claim 20 further comprising at least one dielectric layer coupled to said metal component.
